(19) United States
(12) Patent Application Publication
(10) Pub. No.: US 2025/0198811 A1
(43) Pub. Date: Jun. 19, 2025

(54) CALIBRATION METHOD AND CALIBRATION APPARATUS FOR ANGLE SENSOR

(71) Applicant: Schaeffler Technologeis AG & Co. KG, Herzogenaurach (DE)

(72) Inventors: Zhengtao Lv, Shanghai (CN); Dongsheng Tao, Kunshan (CN)

(73) Assignee: Schaeffler Technologeis AG & Co. KG, Herzogenaurach (DE)

(21) Appl. No.: 18/857,502

(22) PCT Filed: Apr. 19, 2022
(86) PCT No.: PCT/CN2022/087579

§ 371 Date: Oct. 17, 2024

(51) Int. Cl. G01D 18/00; H02P 21/18

(52) U.S. Cl. CPC G01D 18/00; H02P 21/18

(57) ABSTRACT

A calibration method and calibration apparatus for an angle sensor is disclosed. The angle sensor is used for detecting the mechanical angle of a permanent magnet synchronous motor and converting the mechanical angle into an electrical angle, the permanent magnet synchronous motor comprising a stator and a rotor capable of rotating relative to the stator. The calibration method includes a calibration control step for controlling target electrical parameters of the rotor to sequentially reach a plurality of predetermined vector values, and acquiring mechanical angle measurement values of the angle sensor under the corresponding predetermined vector values, each predetermined vector value having a corresponding actual electrical angle; a mapping calibration for establishing a calibration mapping relation table between the actual electrical angle corresponding to each predetermined vector value and the corresponding mechanical angle measurement values; and a measurement value calibration step for when the current mechanical angle measurement value is not present in the calibration mapping relation table, calculating, by means of linear interpolation, the electrical angle corresponding to a current mechanical angle measurement value.

### CROSS-REFERENCE TO RELATED APPLICATIONS

This application is the U.S. National Phase of PCT Appln. No. PCT/CN2022/087579 filed Apr. 19, 2022, the entire disclosure of which are incorporated by reference herein . . .

### TECHNICAL FIELD

The present disclosure relates to the technical field of motors, and in particular to a calibration method and a calibration device for an angle sensor of a motor rotor.

### BACKGROUND

A permanent magnet synchronous motor (PMSM) is a device for converting electrical energy into kinetic energy or converting kinetic energy into electrical energy. A stator of the permanent magnet synchronous motor includes a coil winding, and a rotor of the permanent magnet synchronous motor includes a permanent magnet. The coil winding may generate a rotating magnetic field when three-phase alternating voltages or three-phase alternating currents are applied, thereby driving the rotor to rotate relative to the stator. A geometric angle at which the rotor rotates in a physical space is referred to as a mechanical angle, and a position of the rotor within a cycle of magnetic field variation is referred to as an electrical angle. The angle sensor in the permanent magnet synchronous motor may directly detect the mechanical angle of the rotor and convert the mechanical angle into the electrical angle based on a correspondence.

However, the correspondence between the mechanical angle and the electrical angle may change for various reasons, such as aging, a change in the relative positions of the sensor and the rotor (i.e., magnet). Non-ignorable errors can occur in a rotor angle sensor in the permanent magnet synchronous motor after long-term operation. In FIG. 1, the vertical axis represents a sensor angle, and the horizontal axis represents an actual angle. In this case, a curve illustrating an actual correspondence between the sensor angle and the actual angle deviates from an ideal curve. If there is an error in the electrical angle data provided by the angle sensor, a motor torque fluctuates, even causing the motor to malfunction.

Currently, there are several ways to solve the above problems. The first way is zero-point angle self-learning, in which a continuous phase voltage is applied to a U phase to obtain a zero-point position of the electrical angle. However, this can only calibrate a zero-point angle and fails to solve the problem of deviation of the entire curve. The second way is to provide a standardized device to calibrate data from the sensor, which requires an additional device, resulting in high cost. The third way is to replace or re-install the rotor angle sensor, in which case the motor is disassembled from the vehicle or other installation environment, which is time-consuming and laborious, and increases the cost due to the need for an additional sensor.

### SUMMARY

Therefore, the present disclosure is to solve a technical problem of providing an improved calibration method and calibration device.

The above technical problem is solved by a calibration method for an angle sensor according to the present disclosure. The angle sensor is configured to detect a mechanical angle of a permanent magnet synchronous motor and convert the mechanical angle into an electrical angle. The permanent magnet synchronous motor includes a stator and a rotor being rotatable relative to the stator. The calibration method includes: a calibration control step of modifying a target electrical parameter of the rotor as multiple predetermined vector values successively, and acquiring mechanical angle detection values corresponding to the multiple predetermined vector values from the angle sensor, wherein each of the multiple predetermined vector values corresponds to an actual electrical angle; a mapping calibration step of establishing a calibration mapping relationship table between actual electrical angles and mechanical angle detection values corresponding to the multiple predetermined vector values; and a detection value calibration step of calibrating a current mechanical angle detection value based on the calibration mapping relationship table, and calculating an electrical angle corresponding to the current mechanical angle detection value based on linear interpolation if the current mechanical angle detection value is not in the calibration mapping relationship table. Since actual electrical angles of the rotor at the multiple predetermined vector values are known, calibrated electrical angle detection values of the angle sensor are accurate at least at the mechanical angles (i.e., calibration nodes) corresponding to the multiple predetermined vector values. The electrical angle detection values between these positions (i.e., calibration nodes) may be calculated based on linear interpolation, so that the electrical angle detection values throughout the entire cycle can be calibrated conveniently and accurately.

According to a preferred embodiment of the present disclosure, the calibration method further includes a mapping self-learning step after the detection value calibration step, wherein a mapping relationship calculated based on linear interpolation is added to the calibration mapping relationship table. Through the mapping self-learning step, mapping relationship data in the calibration mapping relationship table is gradually enriched. In subsequent detection, for calibrated mechanical angles, electrical angles corresponding to the calibrated mechanical angles can be directly obtained based on the calibration mapping relationship table.

According to another preferred embodiment of the present disclosure, the rotor includes n pole pairs, and the multiple predetermined vector values at least include vector values corresponding to actual electrical angles of 60°×i, where i=0, 1, . . . , 6n. According to the FOC (Field Oriented Control) method, the rotor of the motor is controlled to stop at these angle positions conveniently and accurately, thereby accurately correcting the electrical angle detection values at the nodes.

According to another preferred embodiment of the present disclosure, an angle between any two adjacent predetermined vector values of the multiple predetermined vector values is equal. In other words, these predetermined vector values of the target electrical parameter are evenly spaced over a cycle of 360°×n, so that the angle sensor has high accuracy throughout the entire rotation cycle of the rotor.

According to another preferred embodiment of the present disclosure, the target electrical parameter is a voltage applied to the stator. The rotor can be stopped at a predetermined electrical angle position by controlling the voltage vector. Alternatively, a current applied to the rotor may be also determined as the target electrical parameter.

According to another preferred embodiment of the present disclosure, the multiple predetermined vector values are equal in modulus. The moduli of the predetermined vector values are set to ensure that the rotor can be driven to rotate and stop at the predetermined angle position. These predetermined vector values are equal in modulus, so that the electrical parameter is controlled more easily during the switching process.

According to another preferred embodiment of the present disclosure, steps of the calibration method are cyclically performed and/or steps of the calibration method are reperformed if a triggering condition is met. Since detection bias in the sensor varies slowly over time, the accuracy of a calibration result can be ensured by cyclically performing the calibration method or re-performing the calibration method as needed. Preferably, the triggering condition may include detecting that data in the calibration mapping relationship table stored on a storage device has been damaged or lost. For example, this detection may be initiated every time the key is powered on to determine whether data has been damaged or lost.

The above technical problem is further solved by a calibration device for an angle sensor according to the present disclosure. The angle sensor is configured to detect a mechanical angle of a permanent magnet synchronous motor and convert the mechanical angle into an electrical angle. The permanent magnet synchronous motor includes a stator and a rotor being rotatable relative to the stator. The calibration device includes: a calibration control module, configured to modify a target electrical parameter of the rotor as multiple predetermined vector values successively, and acquire mechanical angle detection values corresponding to the multiple predetermined vector values from the angle sensor, where each of the multiple predetermined vector values corresponds to an actual electrical angle; a mapping calibration module, configured to establish a calibration mapping relationship table between actual electrical angles and mechanical angle detection values corresponding to the multiple predetermined vector values; and a detection value calibration module, configured to calibrate a current mechanical angle detection value based on the calibration mapping relationship table, and calculate an electrical angle corresponding to the current mechanical angle detection value based on linear interpolation if the current mechanical angle detection value is not in the calibration mapping relationship table. Since actual electrical angles of the rotor at the multiple predetermined vector values are known, calibrated electrical angle detection values of the angle sensor are accurate at least at the mechanical angles (i.e., calibration nodes) corresponding to the multiple predetermined vector values. The electrical angle detection values between these positions (i.e., calibration nodes) may be calculated based on linear interpolation, so that the electrical angle detection values throughout the entire cycle can be calibrated conveniently and accurately.

According to a preferred embodiment of the present disclosure, the calibration device further includes a mapping self-learning module. The mapping self-learning module is configured to add a mapping relationship calculated by the detection value calibration module based on linear interpolation to the calibration mapping relationship table.

According to another preferred embodiment of the present disclosure, the rotor includes n pole pairs, and the calibration control module is configured to determine the multiple predetermined vector values, where the multiple predetermined vector values at least include vector values corresponding to actual electrical angles of 60°×i, where i=0, 1, . . . , 6n. According to the FOC method, the rotor of the motor is controlled to stop at these angle positions conveniently and accurately, thereby accurately correcting the electrical angle detection values at the nodes.

According to another preferred embodiment of the present disclosure, the calibration control module is further configured to determine the multiple predetermined vector values, where an angle between any two adjacent predetermined vector values of the multiple predetermined vector values is equal. In other words, these predetermined vector values of the target electrical parameter are evenly spaced over a cycle of 360°×n, so that the angle sensor has high accuracy throughout the entire rotation cycle of the rotor.

According to another preferred embodiment of the present disclosure, the calibration control module is configured to determine a voltage applied to the stator as the target electrical parameter. The rotor can be stopped at a predetermined electrical angle position by controlling the voltage vector. Alternatively, a current applied to the rotor may be also determined as the target electrical parameter.

According to another preferred embodiment of the present disclosure, the calibration control module is configured to control the multiple predetermined vector values to be equal in modulus. The moduli of the predetermined vector values are set to ensure that the rotor can be driven to rotate and stop at the predetermined angle position. These predetermined vector values are equal in modulus, so that the electrical parameter is controlled more easily during the switching process.

According to another preferred embodiment of the present disclosure, the calibration device further includes a calibration reset module. The calibration reset module is configured to enable the calibration device to cyclically perform calibration on the angle sensor and/or to enable the calibration device to re-perform calibration if a triggering condition is met.

### BRIEF DESCRIPTION OF THE DRAWINGS

The present disclosure is further described below in conjunction with drawings. The same reference numerals are used in the drawings to denote components with same functions. In the drawings:

FIG. 1 is a curve illustrating a correspondence between an electrical angle and a mechanical angle;

FIG. 2 is a flowchart illustrating a calibration method according to an exemplary embodiment of the present disclosure;

FIG. 3 is a schematic diagram illustrating a vector circle in a calibration method according to an exemplary embodiment of the present disclosure; and

FIG. 4 is a schematic diagram illustrating a mapping relationship of a calibration method according to an exemplary embodiment of the present disclosure.

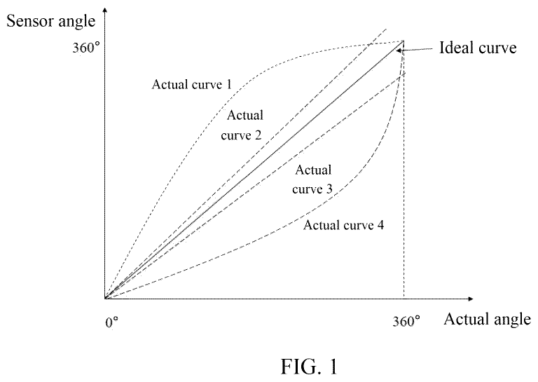

### DETAILED DESCRIPTION

Hereinafter, specific implementations of a calibration method and a calibration device according to the present disclosure are described in conjunction with the drawings. The following detailed description and the drawings are used to exemplarily illustrate the principle of the present disclosure. The present disclosure is not limited to the described preferred embodiments, and the protection scope of the present disclosure is defined by the claims.

According to an embodiment of the present disclosure, a calibration method for an angle sensor in a permanent magnet synchronous motor is provided. The permanent magnet synchronous motor includes a stator and a rotor, where the rotor is rotatable relative to the stator around an axis of rotation. The stator is provided with a coil winding arranged around the rotor, and the coil winding may generate a rotating magnetic field when three-phase alternating voltages or three-phase alternating currents are applied. The rotor is provided with one or more pole pairs formed by permanent magnets. The rotating magnetic field of the stator may generate an electromagnetic force on the permanent magnets of the rotor, thereby driving the rotor to rotate relative to the stator around the axis of rotation. The permanent magnet synchronous motor may include a motor controller. The motor controller may control electrical parameters such as a voltage and/or a current in the coil winding of the stator, thereby controlling the operation of the motor.

The permanent magnet synchronous motor further includes an angle sensor for detecting an operating angle of the permanent magnet synchronous motor, especially the rotor. A geometric angle at which the rotor rotates in a physical space is referred to as a mechanical angle, and a position of the rotor within a cycle of magnetic field variation is referred to as an electrical angle. The angle sensor, for example, an encoder, is a component that can directly detect the mechanical angle of the rotor. The mechanical angle directly detected by the angle sensor may be converted into the electrical angle based on a correspondence. The motor controller may control the operation of the motor based on the electrical angle. With the calibration method according to the present disclosure, the correspondence between the mechanical angle and the electrical angle may be calibrated, thereby acquiring an electrical angle more accurately.

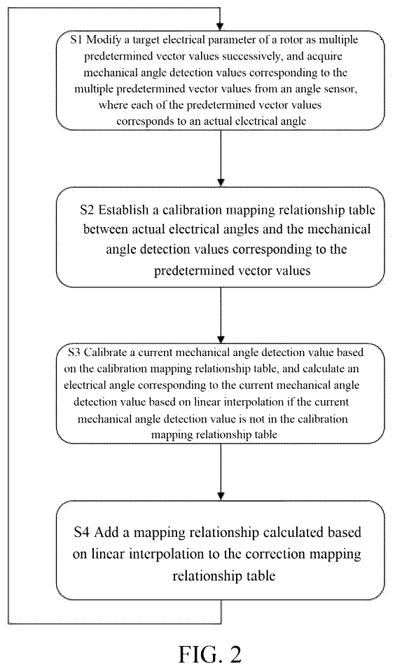

FIG. 2 is a flowchart illustrating a calibration method according to an exemplary embodiment of the present disclosure. As shown in FIG. 2, the calibration method mainly includes steps S1 to S3, and may further additionally include step S4. These steps may be performed by the motor controller. Hereinafter, implementation processes of the various steps in the calibration method are introduced in detail with reference to FIGS. 2 to 4.

In step S1 of calibration control, a target electrical parameter of the rotor is modified as multiple predetermined vector values successively, and mechanical angle detection values corresponding to the multiple predetermined vector values from the angle sensor are acquired. Each of these predetermined vector values corresponds to an actual electrical angle, and these actual electrical angles are known when selecting these predetermined vector values. The target electrical parameter herein is a physical quantity affecting a magnetic field generated by the stator (especially the coil winding) in a circuit, especially the voltage or the current applied to the stator. For ease of control, the voltage is preferably selected as the target electrical parameter.

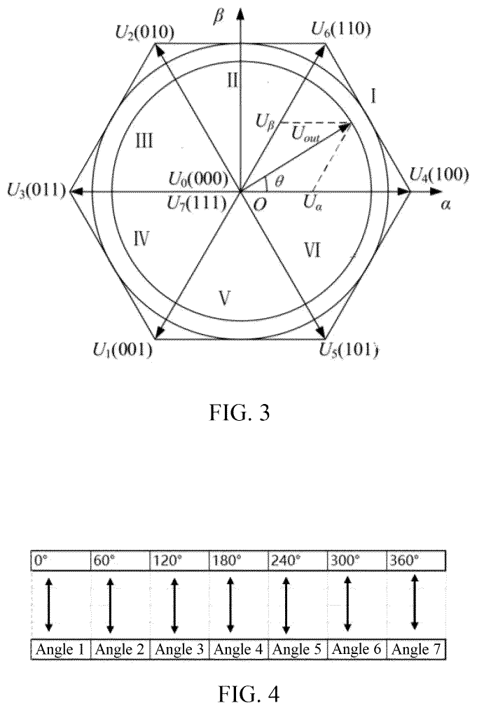

As shown in FIG. 3, a concept of a vector circle is provided in an FOC (Field Oriented Control) method. The generated motor torque changes with a constant voltage applied to the permanent magnet synchronous motor, thus driving the rotor to rotate and ultimately stably stop at a corresponding position (angle). In such case, the angle sensor may detect the corresponding mechanical angle of the rotor.

As is well known in the art, in the vector circle shown in FIG. 3, U₄, U₆, U₂, U₃, U₁, and U₅ represent six voltage vectors with different directions. According to an order shown in FIG. 3, an angle between any two adjacent voltage vectors is 60°. U₄ represents a voltage vector with an electrical angle defined as 0°. U₀ and U₇ represent voltage vectors with a value of zero. If the voltage U₄ is continuously applied to the motor under the control of the motor controller, the rotor eventually stops at 0° (that is, the actual electrical angle). In such case, the mechanical angle detected by the angle sensor is a mechanical angle corresponding to the electrical angle of 0°. This process is also known as zero-point angle self-learning. Correspondingly, applying voltage vectors with different electrical angles enables the rotor to stop at different positions, and mechanical angles corresponding to the electrical angles may be detected by the angle sensor.

As is well known in the art, if switches in the coil winding of the motor are stably in a closed state or opened state, six voltage vectors with an interval of 60° starting from 0° are stably obtained by a combination of the opened state and the closed state of the switches, which are U₄, U₆, U₂, U₃, U₁, and U₅ described above (where 1 and 0 in parentheses shown in FIG. 3 represent switching states). Meanwhile, if multiple switches are controlled to switch between the closed state and the opened state within a period of time, theoretically any vector of the voltage vectors described above may be synthesized. According to the above principle, for each 360° cycle of the electrical angle, voltage vectors such as U₄, U₆, U₂, U₃, U₁, and U₅ that can be stably obtained are preferably determined as predetermined vector values.

As is well known in the art, there is a multiple relationship of the number of pole pairs between a cycle of the electrical angle and a cycle of the mechanical angle. If the rotor of the motor includes n pole pairs, the electrical angle changes 360°×n correspondingly each time the mechanical angle of the rotor rotation is 360°. Therefore, there are a total of 6n+1 voltage vectors with an interval of 60° starting from 0° throughout the entire cycle of the mechanical angle of the rotor, corresponding to electrical angles of 60°×i, where, i=0, 1, . . . , 6n. In a case that 60°×i is greater than 360°, it indicates entering the next cycle of the electrical angle. For outputting a value of the electrical angle, the electrical angle greater than 360° may be converted into an angle within the cycle of 360° according to common knowledge. For example, if i=8, 60°×i is 480°, which is 120° within the second cycle. It can be seen that if the rotor of the motor includes n pole pairs, the selected multiple predetermined vector values may preferably at least include vector values corresponding to the actual electrical angles of 60°×i.

Additional detection angles may be set in order to achieve a higher accuracy. Theoretically, voltage vectors in any direction may be obtained. For example, if a voltage U=(U₄+U₆)/2 is continuously applied, the rotor of the motor eventually stops at a position of an actual electrical angle of 30°. Similarly, the rotor may also stop at an angle such as 30°, 90°, . . . , 330°. Preferably, an angle between any two adjacent predetermined vector values is equal, in order to ensure the accuracy of the calibration result throughout the entire cycle. In other words, vector directions of the selected predetermined vector values are evenly distributed in the circumferential direction. Therefore, after all vector values corresponding to the electrical angle of 60°×i are selected, the additional vector values may be vectors with equal division angles between the selected vector values.

The step S1 is described by taking the voltage serving as the target electrical parameter as an example. It should be understood that a current may be also determined as the target electrical parameter. In a preferred embodiment, moduli (i.e., magnitudes) of the predetermined vector values are equal to each other, which is convenient for controlling the target electrical parameter during switching between the predetermined vector values.

Next, in step S2 of mapping calibration, a calibration mapping relationship table is established between actual electrical angles and mechanical angle detection values (i.e., the mechanical angle detection values at the multiple predetermined vector values acquired by the angle sensor) corresponding to the multiple predetermined vector values. In step S1, based on an order of the electrical angles (that are 0°, 60°, . . . , 360° in the embodiment) corresponding to the predetermined vector values, mechanical angles acquired through detection may be sequentially recorded as an angle 1, an angle 2, and so on. As shown in FIG. 4, a one-to-one mapping relationship between electrical angles and detected mechanical angles is established. That is, each of the electrical angles is associated with a corresponding detected mechanical angle. This mapping relationship is recorded in the calibration mapping relationship table.

Here, detection and mapping establishment are performed at the multiple predetermined vector values, steps S1 and S2 may be performed sequentially or alternately. In a case that steps S1 and S2 are performed sequentially, mechanical angles at all the predetermined vector values are detected first, and then the mapping is established. In a case that steps S1 and S2 are performed alternately, a mechanical angle is detected at one of the predetermined vector values, and a mapping relationship between the mechanical angle and the electrical angle corresponding to the predetermined vector value is established. Then, the above process is repeated for the next predetermined vector value.

In step S3 of detection value calibration, a current mechanical angle detection value may be calibrated based on the calibration mapping relationship table. If the angle sensor detects that the rotor is located at a mechanical angle with a mapping relationship already established in step S2, the mechanical angle is converted into the corresponding electrical angle based on the calibration mapping relationship table. For example, if the mechanical angle of the rotor is detected as an angle 3 by the angle sensor, the electrical angle corresponding to the angle 3 is acquired as 120° based on the mapping relationship, so that electrical angles corresponding to all predetermined vector values can be calibrated.

If the current mechanical angle detection value is not in the calibration mapping relationship table, an electrical angle corresponding to the current mechanical angle detection value may be calculated based on linear interpolation. Theoretically, since predetermined vector values for any angles may be acquired, mechanical angles corresponding to any actual electrical angles may also be acquired. However, not all the angles may be detected in the actual calibration process. Therefore, an electrical angle corresponding to a mechanical angle detected by the angle sensor located between two mechanical angles at two adjacent predetermined vector values is calculated based on linear interpolation. Specifically, if a mechanical angle detected by the angle sensor is located between two mechanical angles detected in step S1 instead of the mechanical angle detected in step S1, the two mechanical angles serve as two nodes, and an electrical angle corresponding to any mechanical angle between the two nodes may be calculated from the two nodes based on linear interpolation. The calculation method of linear interpolation is well-known and is not repeated herein.

Preferably, the calibration method may further include an additional step S4 of mapping self-learning. The step S4 of mapping self-learning is performed after the step S3 of detection value calibration. Specifically, after the step S3 of detection value calibration, a mapping relationship calculated based on linear interpolation may be added to the calibration mapping relationship table. Through the step S4 of mapping self-learning, mapping relationship data recorded in the calibration mapping relationship table is gradually expanded, which is beneficial to acquiring the calibrated electrical angle more quickly in the subsequent operation process.

Furthermore, preferably, the above steps of the calibration method may be re-performed cyclically based on time or based on a preset condition. Specifically, the various steps of the calibration method may be performed cyclically. Alternatively or additionally, the various steps of the calibration method may be re-performed if a triggering condition is met. The cycle may be preset based on a variation speed of detection deviation of the sensor, for example, the cycle may be one day, one week, or one month. Examples of the triggering condition may include detecting that data in the calibration mapping relationship table stored on a storage device is damaged or lost. The data damage and data loss may often occur due to a reliability issue of the storage device. For example, this detection may be initiated every time the key is powered on to determine whether data has been damaged or lost. If it is determined that data is damaged or lost, the calibration method may be re-performed to establish an additional mapping relationship table.

According to another embodiment of the present disclosure, a calibration device for performing the above calibration method is further provided. The calibration device may include corresponding modules for performing various steps in the calibration method. Specifically, the calibration device may include a control module, a mapping module, and a calculation module.

The calibration control module is configured to perform step S1. Specifically, the calibration control module may be configured to modify a target electrical parameter of the rotor as multiple predetermined vector values successively, and acquire mechanical angle detection values corresponding to the multiple predetermined vector values from the angle sensor, where each of the multiple predetermined vector values corresponds to an actual electrical angle.

As described above, if the rotor includes n pole pairs, the calibration control module may preferably determine the multiple predetermined vector values, where the multiple predetermined vector values at least include vector values corresponding to actual electrical angles of 60°×i, where i=0, 1, . . . , 6n. Preferably, the calibration control module may further determine the multiple predetermined vector values, where an angle between any two adjacent predetermined vector values of the multiple predetermined vector values is equal. Preferably, the calibration control module may determine a voltage or a current applied to the stator as the target electrical parameter. Preferably, the calibration control module may control the multiple predetermined vector values to be equal in modulus.

The mapping calibration module is configured to perform step S2. Specifically, the mapping calibration module may be configured to establish a calibration mapping relationship table between actual electrical angles and mechanical angles corresponding to the multiple predetermined vector values.

The detection value calibration module is configured to perform step S3. Specifically, the detection value calibration module may be configured to calibrate a current mechanical angle detection value based on the calibration mapping relationship table, and calculate an electrical angle corresponding to the current mechanical angle based on linear interpolation if the current mechanical angle detection value is not in the calibration mapping relationship table.

Preferably, the calibration device may further additionally include a mapping self-learning module for performing step S4. Specifically, the mapping self-learning module is configured to add a mapping relationship calculated by the detection value calibration module based on linear interpolation to the calibration mapping relationship table.

Preferably, the calibration device may further additionally include a calibration reset module for restarting various steps of the calibration method. Specifically, the calibration reset module is configured to enable the calibration device to cyclically perform calibration on the angle sensor. Alternatively or additionally, the calibration reset module is configured to enable the calibration device to re-perform calibration on the angle sensor if a triggering condition is met.

The calibration device may be integrated into the motor controller of the permanent magnet synchronous motor. Especially, the various modules of the calibration device may be virtual functional modules in the motor controller.

With the calibration method and the calibration device according to the present disclosure, the actual electrical angle of the rotor is acquired based on the FOC characteristics, for correcting the angle data of the sensor. The application process of the calibration method and the calibration device is convenient and fast without additional devices. The method may be used for calibration offsets in the rotor, the sensor, and other components, so that the calibration method and the calibration device have high robustness.

Although possible embodiments have been described illustratively in the above description, it should be understood that there are still a large number of embodiment variations through combinations of all known technical features and embodiments as well as those that are readily apparent to those skilled in the art. In addition, it should be further understood that the exemplary embodiments are merely examples and shall not limit the protection scope, application and construction of the present disclosure in any way. The foregoing description is more intended to provide those skilled in the art with a technical guidance for converting at least one exemplary embodiment, in which various changes, especially changes in the functions and structures of the components, can be made as long as they do not depart from the protection scope of the claims.

1. A calibration method for an angle sensor, the angle sensor configured to detect a mechanical angle of a permanent magnet synchronous motor and convert the mechanical angle into an electrical angle, the permanent magnet synchronous motor comprising a stator and a rotor being rotatable relative to the stator,
wherein the calibration method comprises:
modifying, in a calibration control step, a target electrical parameter of the rotor as a plurality of predetermined vector values successively, and acquiring mechanical angle detection values corresponding to the plurality of predetermined vector values from the angle sensor, wherein each of the plurality of predetermined vector values corresponds to an actual electrical angle;
establishing, in a mapping calibration step, a calibration mapping relationship table between actual electrical angles and mechanical angle detection values corresponding to the plurality of predetermined vector values; and
calibrating, in a detection value calibration step, a current mechanical angle detection value based on the calibration mapping relationship table, and calculating an electrical angle corresponding to the current mechanical angle detection value based on linear interpolation if the current mechanical angle detection value is not in the calibration mapping relationship table.

2. The calibration method according to claim 1, further comprising a mapping self-learning step after the detection value calibration step, wherein a mapping relationship calculated based on linear interpolation is added to the calibration mapping relationship table.

3. The calibration method according to claim 1, wherein the rotor comprises n pole pairs, and the plurality of predetermined vector values at least comprise vector values corresponding to actual electrical angles of 60°×i, wherein i=0, 1, . . . , 6n.

4. The calibration method according to claim 3, wherein an angle between any two adjacent predetermined vector values of the plurality of predetermined vector values is equal.

5. The calibration method according to claim 1, wherein the target electrical parameter is a voltage applied to the stator.

6. The calibration method according to claim 1, wherein the plurality of predetermined vector values are equal in modulus.

7. The calibration method according to claim 1, wherein steps of the calibration method are cyclically performed and/or steps of the calibration method are re-performed if a triggering condition is met.

8. The calibration method according to claim 7, wherein the triggering condition comprises detecting that data in the calibration mapping relationship table stored on a storage device is damaged or lost.

9. A calibration device for an angle sensor, the angle sensor configured to detect a mechanical angle of a permanent magnet synchronous motor and convert the mechanical angle into an electrical angle, the permanent magnet synchronous motor comprising a stator and a rotor being rotatable relative to the stator,
wherein the calibration device comprises:
a calibration control module, configured to modify a target electrical parameter of the rotor as a plurality of predetermined vector values successively, and acquire mechanical angle detection values corresponding to the plurality of predetermined vector values from the angle sensor, wherein each of the plurality of predetermined vector values corresponds to an actual electrical angle;
a mapping calibration module, configured to establish a calibration mapping relationship table between actual electrical angles and mechanical angle detection values corresponding to the plurality of predetermined vector values; and
a detection value calibration module, configured to calibrate a current mechanical angle detection value based on the calibration mapping relationship table, and calculate an electrical angle corresponding to the current mechanical angle detection value based on linear interpolation if the current mechanical angle detection value is not in the calibration mapping relationship table.

10. The calibration device according to claim 9, further comprising a mapping self-learning module,
wherein the mapping self-learning module is configured to add a mapping relationship calculated by the detection value calibration module based on linear interpolation to the calibration mapping relationship table.

11. The calibration device according to claim 9, wherein the rotor comprises n pole pairs, and the calibration control module is configured to determine the plurality of predetermined vector values, wherein the plurality of predetermined vector values at least comprise vector values corresponding to actual electrical angles of 60°×i, wherein i=0, 1, . . . , 6n.

12. The calibration device according to claim 11, wherein the calibration control module is further configured to determine the plurality of predetermined vector values, wherein an angle between any two adjacent predetermined vector values of the plurality of predetermined vector values is equal.

13. The calibration device according to claim 9, wherein the calibration control module is configured to determine a voltage applied to the stator as the target electrical parameter.

14. The calibration device according to claim 9, wherein the calibration control module is configured to control the plurality of predetermined vector values to be equal in modulus.

15. The calibration device according to claim 9, further comprising a calibration reset module,
wherein the calibration reset module is configured to enable the calibration device to cyclically perform calibration on the angle sensor and/or to enable the calibration device to re-perform calibration if a triggering condition is met.

16. The calibration device according to claim 15, wherein the calibration reset module is configured to re-perform calibration upon detecting that data in the calibration mapping relationship table stored on a storage device is damaged or lost.
